(19) United States
(12) Patent Application Publication
(10) Pub. No.: US 2002/0010789 A1
(43) Pub. Date: Jan. 24, 2002

(54) Broadcast multimedia delivery system

(76) Inventor: Frank H. Lord, Beaconsfield (GB)

Correspondence Address: HANDAL & MOROFSKY, 80 WASHINGTON STREET, NORWALK, CT, 06854, US

(21) Appl. No.: 09/848,099

(22) Filed: May 3, 2001

Related U.S. Application Data
(60) Provisional application No. 60/201,793, filed on May 4, 2000.

(51) Int. Cl. G06F 15/16

(52) U.S. Cl. 709/231; 709/217

(57) ABSTRACT

A system and method for providing electronic mass multimedia data transfer from a central data source of multimedia data simultaneously to numerous geographically dispersed subscribers having personal computers, further providing information to each subscriber based exclusively on the proved interests of that individual subscriber. In particular, the invention is well-suited as an improved method for distributing newspapers and multimedia content.

### STATEMENT REGARDING FEDERALLY SPONSORED RESEARCH OR DEVELOPMENT

(Not applicable.)

### BACKGROUND OF THE INVENTION

Conventional distribution systems for newspapers and other types of printed media involve many costly and time-consuming steps. For example, the newspapers are often printed at a central city site and require manual carrier distribution to subscribers throughout the city region or county. This introduces distribution costs, time delays and waste on account of overprinting.

Furthermore the cost and waste of newsprint is a significant social problem incurred because of the temporary value nature of newspapers resulting in high newsprint cost, environmental pollution, loss of forestation and complex disposal procedures. The comprehensive subject matter in newspapers for reaching the combined needs of a large subscribing audience results in a great waste of resources in that few subscribers are interested in the entire newspaper and immediately discard significant portions. Nevertheless, providing a more individualized newspaper based on each subscriber's interests is highly impractical in this format.

The printed media arts, such as newspapers and magazines, have already developed rapid electronic distribution systems for providing time-sensitive newspaper copy to remotely located towns and cities for printing and local distribution to subscribers. Thus, electronic mass transmission of the media copy has been formatted for use in printing plants using conventional printing presses and requiring local distribution by conventional carriers.

However, any attempts at direct publisher to subscriber electronic communications have been costly and limited in scope because of the necessity to allot wide band radio transmission channels and/or dedicated telephone lines for point-to-point connections in electronic distribution systems. In the case of point-to-point facsimile systems, dedicated communication lines are required to avoid the problems encountered with overloaded connections and busy lines when communications are simultaneously required to many distribution points through the telephone switching systems. Furthermore the accompanying telephone charges are costly and uncontrollable by the media source and tie up telephone lines.

Similarly computer networks, such as the “Internet”, can provide for point-to-point connections between sending and receiving stations over dedicated connection lines. These are not suitable for processing such mass audiences as newspaper subscribers, further more they require such extensive charges, protocol and formatting requirements for massive data transmissions that it is not feasible to provide a simple low-cost newspaper delivery system. The computer network facilities cannot process such massive data routing and traffic requirements to so many subscribers without becoming jammed in the same way that commercial telephone switching networks are tied up during heavy traffic conditions. Accordingly, the content of most news websites is dramatically lower than a newspaper or other periodical. Therefore, there exists a need for a significantly improved newspaper distribution system.

### SUMMARY OF THE INVENTION

An objective of this invention is to provide an instantly accessible low-cost communication system for the mass transmission of printed media copy simultaneously to large numbers of computer users from a media source for viewing at various geographical locations. It is an accompanying objective of the invention to provide a simplified inexpensive mass data communication system to broadcast massive data, for reproducing newspapers on personal computers. A further objective of this invention is the transmission of multimedia data such as video, data from the Internet and computer games, E-mail and Voice-mail.

It is a further objective of this invention to provide a newspaper system that provides content having personal significance or of interest to each individual subscriber.

It is a further objective of this invention to provide a practical, low waste, low cost and substantially instantaneous electronic newspaper distribution system with additional multimedia material, such as sound video, computer, games, and the delivery of Voice-mail, E-mail, Internet files, and other information to computer users. Thus, the subscriber's personally selected newspaper and multimedia files can be stored electronically in a computer system for viewing and waste free disposal, thereby avoiding the conventional consumption of newsprint.

The present invention provides a system for broadcasting multimedia information to many, or all computers within range simultaneously, information such as newspapers, magazines, advertisements, music, books, games, video clips, computer software, and Internet data and E-mails, Voice mails, etc. The broadcast can also include hyperlink software to connect the user to web sites. Digital data is transmitted/broadcast to computers within range of a transmitter. The data for the broadcast can transmitted, or uploaded, from its source to a server or broadcaster. Sources may include news providers, newspapers, magazine publishers, multimedia companies, television companies, Internet servers, advertisers, etc.

The server sends a data stream to a transmitter, which broadcasts the data stream; the broadcasts can be terrestrial or by satellite in the customary wavelength bands, such as RF, VHF, UHF, cell phone or other wireless transmission systems. The data stream can be broadcast using cell phone transmitters to broadcast the data stream to computers, PC's, laptops, hand held, (e.g. Palm™ Computers) or any device capable of displaying the data, and that is fitted with one or more receiving module. The system for receiving the data stream is described in detail below. The cell phone broadcasts can be multi-channel broadcasts, as the inventive receiving module does not have to be confined to single, or double channel receivers, as with a cell phone connection, the computer can be made to receive many channels of data simultaneously.

It is envisaged that the broadcasts containing the bulk of the newspaper, or multimedia broadcast, can be, as much as possible, transmitted in the middle of the night (local time for the subscriber) when the cell phone and other wireless service providers' bandwidth is historically under-utilized. Additionally, there can be updates during the day as News and other new material becomes available. The use of cell phone wave lengths to broadcast the data is advantageous as the radio wave used by this form of communication requires a relatively small aerial compared with other radio wave bands and the short wave lengths penetrate buildings giving the subscriber-user better reception when on the move, or when a user's computer is within a building. There may well also be a demand for the broadcast of multimedia data by the envisaged method on many other radio and television wave lengths such as DAB, FM, etc., and by satellite.

The display of newspapers may appear on the computer screen in a similar form and lay out to conventional newspapers. As there is no time delay when turning pages, it may not be necessary to display a menu of stories, a layout that the Internet has had to adopt for the display of newspaper data. However, the newspaper may be laid out with a menu format if the service provider wishes, or to facilitate the commanding of the multimedia content of the broadcasts.

If the broadcast is for transmission by satellite, the data stream containing the information is transmitted from a ground transmitter to a satellite or a constellation of satellites to broadcast the data stream to a larger range. The use of satellites to put out data transmissions to be received by a myriad of end users simultaneously, effectively multiplies the bandwidth by the number of such users.

The data stream is received by the aerial/modem, which includes any device capable of receiving a data stream, such as a cell phone or PC card, etc. The data stream is processed by the computer, web TV, or a dedicated or other device capable of digital processing and converted to the operative format by the software. Such devices, in accordance with the invention will be kept on all the time or turned on in accordance with a schedule.

Preferably, the multimedia data broadcasts will be receivable by the computer users receiver enabled computer within range of the broadcast transmitter without the receiver having to initialize with the broadcaster. The computer receiver will be able to receive the broadcast in the same way as when the radio is switched on the sound comes out, that is, without the radio owner being required to initialize with the broadcaster. However, there might be an advantage to the service provider in requiring the computer user to initialize with the broadcaster for any reason such as targeted multimedia broadcasts. For example, to broadcast to people who move around, information that is specific to them for their work, travel, etc., and to enable the service provider to keep a database with information about their customers.

The data stream may be encoded, encrypted and/or compressed. The broadcasted data stream is stored on the computers memory-system or on a memory card within the receiving module.

Selling advertising content within the multimedia broadcasts is seen as the main method of revenue generation. Individuals, or groups who receive the data broadcasts, referred to herein as computer users, may alternatively or additionally pay a fee for the service.

Those individuals interested in receiving the broadcasted data, will install software contained on CD-ROM or other computer media from the Internet, or download the software from within a broadcast, if this method is chosen by the service provider. Software can also allow the receiver to customize some of the systems features.

The designed software will be required to manage the receiving of broadcasts and also perform a series of tasks for the user. It will be required to perform whilst the computer is either switched on or in stand-by mode, or switched off. The software is required to activate the computer, this command can be by the time of the required broadcast, and the software instructs the computer to start to record from a known radio wave band, at a known time, to the computers memory file, the multimedia data broadcast, that the user has commanded the computer to store. Alternatively, again from any mode, on, suspend, or off, the software commands the computer to search for an incoming data packet transmitted at the beginning of the required broadcast, and by recognizing the information within the data packet, the software then commands the computer to prepare itself for the incoming broadcast by switching on the computer, if not already switched on, and then to download the broadcast to the users chosen memory file within the computer, or within a memory capability within the receiving module. It is envisaged that the software will be made available to the user via an Internet web site, or by a CD or by transmitting the software in a broadcast. There are many ways that the software can be delivered to the computer. It is envisaged that once the computer user has the software installed on their computer, the functionality of the software can be updated by the service provider broadcasting the updated software or by other methods. The software can have a menu that gives the computer user a choice of newspaper and other multimedia broadcasts to choose from, by clicking icons on the menu the software then commands the computer to store these broadcasts when they are transmitted to the memory of the computer or to the memory of the receiver module. The software will have the ability to search incoming broadcasts that the user would like to store for future use. The software will be able to store broadcasts that are chosen as likely to contain data that is of interest to the computer user, and then once the broadcast is stored, the software commands the computer to scan the broadcast, searching for multimedia data that is of interest to the computer user. When the computer has found data of interest, it may then store the broadcast to a memory file for the computer user to view at their convenience. The unwanted broadcasts that have been stored and searched are deleted from the memory of the computer by the software. The searching of the multimedia broadcast can be either by searching via an information packet, telling the computer an outline of the content of the broadcast at the beginning of the transmission, or by searching for key words or groups of words or by sound recognition or any other means that can be developed, such as photo or video recognition, for example.

It is envisaged that multimedia broadcast data that has been stored, scanned and searched and then re-filed or downloaded for the computer users later viewing, with the unwanted data deleted from the computers memory to make room for storing wanted data, will be an integral part of choosing and the software handling of the multimedia broadcasts. To give an example, the computer user might well instruct his computer to download all broadcasted multimedia data that is about a particular pop star. The software can then scan and store a list of likely broadcasts for recordings of the artist in question. It will also by scanning by words and sounds and all other methods of data recognition, be able to record to the memory of the computer and then scan, identify, and then re-save to a predetermined file the subject pop star giving a news interview that could not have been found by data information at the beginning of the broadcast. As by its nature, it was a news story that could well have been broadcast without an appropriate data information packet preceding it.

Using the designed software, computer users may select the specific material to be received, and select storage options, and the broadcasts that are received. The user may also select to delete existing data when receiving new data. This aids in conserving the computer's memory resources. The allowable options and available material can be listed by the software, which can be updated via the Internet, CD-ROM, data transmissions or broadcast.

Broadcasts can contain software that can optionally and additionally perform tasks. For example, there can be, embedded in the broadcast, the address of the web site that the user can select, which will hyperlink the user to the web site with that address, so that whilst the user is still reading or viewing broadcasted data. The web site is then on line when the user wishes to view the web site. Alternatively the broadcasted hyperlink or other data can be stored by the software to be used at a later time in the form of a bookmark or the like. The broadcasted digital data can contain any command that it is possible to transmit as a digital broadcast.

The data for the text, photos, video programs, computer games, music, animations, etc., can be abbreviated using codes to shorten transmission times and to save space on the computers memory, enabling the computer/receiver to store more information.

The broadcast can include, any traditionally, printed media, such as news, advertisements, cartoons, etc., as well as executable media like sound tracks, computer games, animated cartoons, scrolling pictures, and video clips, television programs, and computer software. Any part of which, if the relevant data is embedded in, or part of, the broadcast can be selected by the users, to take the user, to their Internet server or, to connect then by any other means, to the organization, individual, or the advertiser.

Within the data there can be video clips, computer games, animated cartoons, etc., that contain embedded digital information, this data can contain static or dynamic Universal Resource Locators (URL's), which can be web site addresses, that the user can click onto using a mouse or a remotely control device or key board or over means, to hyperlink to the URL's, which direct the user to the appropriate resources, be it an Internet site or other location or service to access further data. Alternatively the software can store the URL/Web site address as a bookmark for future use.

Information broadcast sent “downstream” to the receivers is broadcast, and information sent “upstream” from the receiver is via Internet connection, telecommunications, being a land line or a cell phone, satellite connection, postal letter, fax, etc. For example, a reader's letter can be E-mailed, or a text message, can be sent to the broadcaster/service provider, and then the E-mail or information contained in it can be broadcast within the next and subsequent broadcasts. Downstream data may be broadcast periodically, but it can be broadcast constantly and updated and repeated throughout the day.

In accordance with a preferred embodiment of the invention, all transmitted data is associated with a data block and each data block has an identifier (such as a file name). Updates may be made by substituting an updated data block for an older one, both with the same identifier, thus allowing proper updating of a periodical, even when a particular update has been missed by a subscriber.

It is also envisaged that multi channel broadcasting of the multimedia data can enhance the transmission rates. For example, when broadcasting the multimedia data, using a cell phone broadcasting network, it might be advantageous to broadcast the data over many channels simultaneously, this will reduce the time that broadcast takes to transmit a given amount of information to the computer user.

For the receiver-computer to receive these multi channel broadcasts it will be necessary for the receiver-computer to be developed to be able to receive the many channels of information simultaneously. And to be able to receive many channels of data separately to be able to store different broadcasts that are sent out at the same time.

The software for the computer-receivers will be able to record to the computers memory, more than one multimedia data broadcast at a time. This will enable the user to download more than one broadcast to the computers memory at a time, so that the computer can store overlapping broadcasts and receive Voice mail and E-mail messages at the same time as downloading and searching multimedia data broadcasts.

Additionally, broadcast of multimedia data can include computer software and data, as well as newspapers, magazines, books, cartoon animations, videos, games, computer games, music, sound, with embedded data such as hyperlink data, etc.

All broadcasted multimedia data can be compressed. The data can be compressed or encoded to reduce transmission times of encoded text, photographs, video, sound, software, etc., and to save capacity within the computers memory files. All conventional data compression methods may be used.

Additional information such as E-mail, Voice-mail and pager messages can be broadcast to the computer user. The computer uses its own codes to recognize that the message is directed to a given computer by the preceding packet of data or by any other method of recognition, the designed software then downloads the information to the computer's memory and then if the message data is encrypted, decodes their information enabling the computer user to receive E-mails, Voice mails and personal messages, etc., these data can be sent sent directly to computers and portable computers even when the user is carrying the computer whilst out and about, without the user having to connect to a network, or dial up to a service provider. It will be necessary if the broadcast is on a local or cell phone transmitter for the computer user to register with the, E-mail, Voice mail, Internet, data, etc., service provider, the address-location, where the computer is located so that the service provider can, in the case of a cell phone network, conserve their resources by, only broadcasting the required information to the cell that the computer user computer is in.

When the computer has received a message, being an E-mail or a Voice-mail, etc., the designed software will alert the user that there is a new message stored in memory. The alert to the user may be provided by a command that causes generation of a sound via a sound card and speakers or other sound-producing device, or via any other method designed to signal the user to the new data. The message broadcasting service can be offered as a free service, as an advertising message or advertisement sent with the messages to pay or help pay for the broadcast expenses.

To help the user find specific information within broadcasts, without using the directory or broadcasted directory or other means. The envisaged designed software program will instruct the computer to store selected transmissions to the computer memory, or to an external memory capacity within the aerial receiver module, once the data is stored within the computers memory, to then search the stored data by categories. Such as key words, phrases, titles, photographs, images, articles etc. or by embedded software, or by reference information etc., or by searching for web site addresses, or by hyperlink, or by any combination of words and data, software, etc. The software finds parts of the broadcast that has been stored and scanned, that are of interest to the computer user. Those part or parts which are of interest, can then be directed by the designed software to be stored in a selected data memory file, and then the software can command unwanted data to be, erased from the memory space that it is taking up on the computer/receiver module.

For example, if a user has a particular interest in say sailing, the designed software can store broadcasts from likely service providers or channels and then scan the stored data for stories/articles about boats and sailing and harbors etc and when the information of interest is stored to another file for the computer users future use. The unwanted data can then be deleted from the memory of the computer to provide space.

The invention can also be used with a cell phone type transmission link to a service provider, this can be external or built into the computer, alternatively, communication with the service provider can be by use of conventional telephone lines or any other method of communication. Instructions between the computer user and the multimedia data broadcaster, can command the broadcast of multimedia data to the computer. For example, the data that is broadcasted by demand could be a particular file requested from the Internet, using the very fast transmission, described above, being a multi-channel broadcast. The information requested can be delivered to the memory of the personal computer in a very short period of time, making what appears to the computer user to be an instant Internet. Due to the amount of data broadcast in a very short period of time, the received data can be stored by the designed software to a memory file of the computer, and then the information received can be viewed from the computers memory. The broadcaster can use information such as postal address or zip code, or by telephone dialing codes, or cell phone initializing data, either from a built in cell phone, or from a mobile phone that the computer user is carrying whilst receiving the broadcast, telling the service provider where, in which cell, to broadcast the requested Internet file, Voice mail, E-mail, or other data, to find the users computer. In this way the broadcast can be directed to the computers users aerial receiver enabled computer, saving the service provider broadcasting unnecessarily to areas where the information is not required, and providing service optionally at additional cost, where internet service is not available. The requested data, broadcast in this way, will then be stored on the memory of the computer by the designed software for viewing by the computer user.

The multimedia-broadcast receiver is envisaged to receive the multimedia broadcast data. It can be an external module with a built in memory capacity. This module can be designed to be carried by the computer user, receiving and storing multimedia broadcasts, that are of interest to the user and when the user has access to a computer. The module can be interfaced with that computer and the user can then view their selected multimedia broadcast data that is stored on their portable receiver module. The external receiving module can have its own computing ability and may well need it's own built in power sources. This module interfaces with computers, or it can be built in as part of a computer, this module is referred to in this document as the receiver or receiver module or aerial receiving module.

The receiver aerial and the computer can be built into a cell phone. The aerial can be used for both the cell phone, and to receive the multimedia broadcasts.

A portable computer having a viewable folding screen may also be used in accordance with this invention. This folding screen will have more than one screen, possibly three screens. The data is displayed over the screens, making them appear as one screen when unfolded. One or more of the screens may be a touch sensitive key pad to enable the user to instruct the computer or to type a letter or E-mail or the like. This computer has a receiver that will give the computer the ability to receive information broadcast to the computer. The computer can be part of a cell phone and have cell phone capability. The designed software will store the chosen broadcasts, that the computer -receiver can receive on more than one channel at a time. The software then instructs the computer to store these separate broadcasts to the computer's memory in a way that the user can access the stored information almost instantly. The aerial might well also act as an aerial for a built in cell phone, as well as a multi band receiver for downloading multimedia broadcasts. The computer will have designed software that will store on the computers memory, broadcasts that are of interest to the computer user. These broadcasts can be chosen by broadcast name, or by title or by subject in that, the designed software will have the ability to instruct the computer to store broadcast data, for the purpose of the computer scanning the data for a requested subject of interest, these subjects can be found by searching for key words within the data or by a series of words or by embedded data or by photo or sound recognition or by whatever method of searching the user instructs the computer to search by. Scanning and storing the requested data so that when the user wishes, the user can read their newspaper or view their television program or listen to the radio or play a computer game or read an E-mail or listen to voice mail or access any form of data that can be broadcast in this way. The user will be able to use the cell phone part of the device to request information, one form of information is from the Internet. The information is received to the memory of their computer via the broadcast receiving capacity of their receiver-computer. These transmissions can be sent to the computer user by many channels of broadcast simultaneously, making the receiving of the information very fast and giving the user the impression that the data requested from the Internet has arrived on their computer screen instantly. These services will also be available to receiver enabled desk top computers or fixed position computer. The computer user can request Internet and other data by land line or cell phone connection or any other means, and receive the information by the very fast multi channel broadcast. The user of a receiver enabled computer as described in this envisaged invention, will at all times be able to access their choice of newspapers, television programs, radio programs, music, computer games, etc., and be able to read received E-mails and listen to received voice mail messages from the memory of their computer.

It is envisaged that the computer screen can be also be made to be a solar panel, to absorb energy in the form of light and heat and convert the energy into electricity to recharge the battery. The casing of the computer may also be made of a solar energy-absorbing material, for the purpose of recharging the battery.

Other broadcasting media such as FM, DAB, radio television, and others, can be used for the transmission of multi media broadcasts in accordance with this invention. In some cases the data can be viewed as it arrives at the computer, such as the viewing of television data broadcast by radio wave in a digital form.

Please note that for the purposes of this document the word computer is used to describe all devices capable of displaying the multimedia broadcasts, and all devices that are capable of receiving the multimedia broadcast, storing the data and any part there of.

Also for the purpose of this document the word multimedia is used to describe both conventional multimedia such as radio, video, music, newspapers etc., and multimedia data such as computer software programs and the like.

### BRIEF DESCRIPTION OF THE SEVERAL VIEWS OF THE DRAWING

One or more embodiments of the invention and of making and using the invention, as well as the best mode contemplated of carrying out the invention, are described in detail below, by way of example, with reference to the accompanying drawings, in which:-

FIG. 1 is a block flow diagram illustrating the data flow in one embodiment of a broadcast multimedia distribution system according to the present invention;

FIG. 2 is a flow chart useful for illustrating the broadcasting process in a multimedia distribution system as illustrated in FIG. 1;

FIG. 3 is a flow chart useful for illustrating the broadcast receiving process in a multimedia distribution system as illustrated in FIG. 1;

FIG. 4 is an example of a first page of a broadcast in a multimedia distribution system as illustrated in FIG. 1;

FIG. 5 is an example of a second page of a broadcast in a multimedia distribution system as illustrated in FIG. 1;

FIG. 6 is a flow chart useful for illustrating the profile updating process a multimedia distribution system as illustrated in FIG. 1;

FIG. 7 is a flow chart providing an overview of the broadcasting process for another embodiment of the multimedia distribution system;

FIG. 8 is a flow chart providing an overview of the data receiving process for the embodiment of the multimedia distribution system illustrated in FIG. 7;

FIG. 9 is a flow chart useful for illustrating the manner in which users may contact broadcasters and data sources for the embodiment of the multimedia distribution system illustrated in FIG. 7;

FIG. 10 is a flow chart illustrating a control program for use with the inventive multimedia distribution system; and,

FIG. 11 is a flow chart illustrating a third embodiment of the present invention wherein the broadcast is transmitted over digital radio.

### DETAILED DESCRIPTION OF THE INVENTION

The following more detailed description of the invention is intended to be read in the light of, or in context with, the preceding summary and background descriptions. Unless otherwise apparent, or stated, directional references, such as “up”, “down”, “left”, “right”, “front” and “rear”, are intended to be relative to the orientation of a particular embodiment of the invention as shown in the first numbered view of that embodiment. Also, a given reference numeral indicates the same or a similar structure when it appears in different figures.

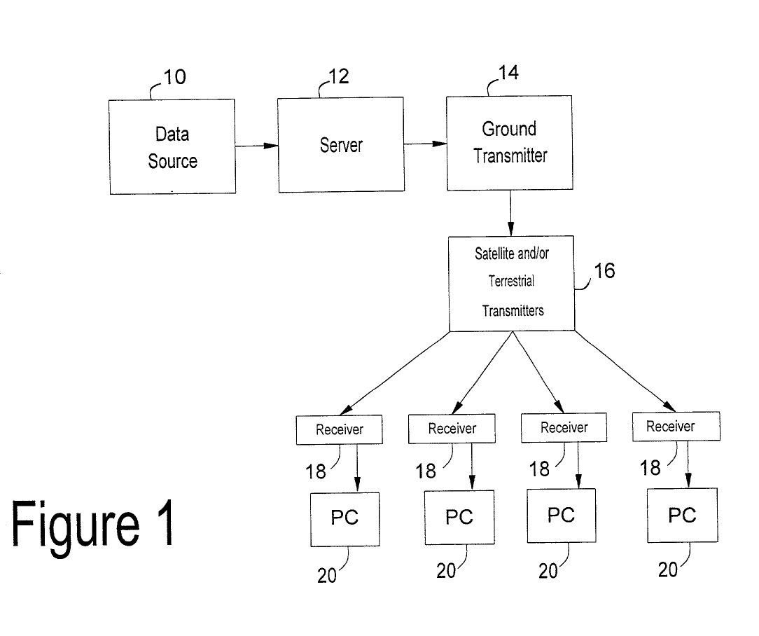

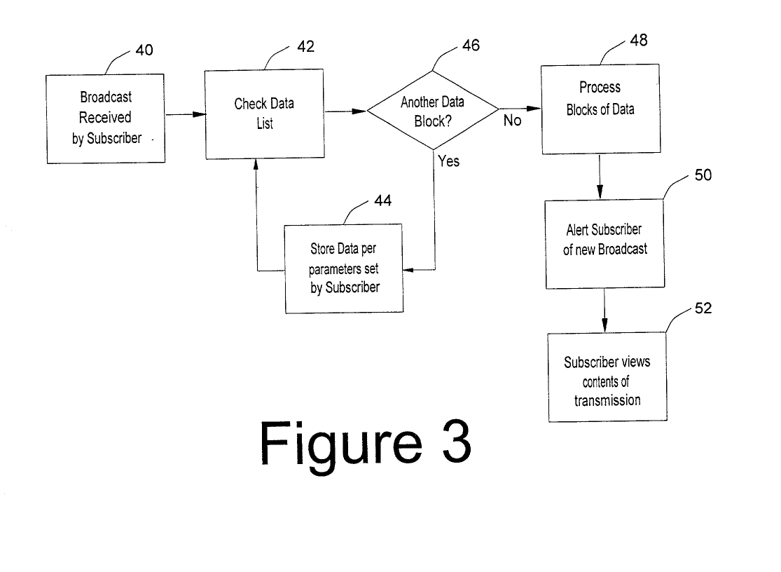

FIGS. 1-6 illustrate one embodiment of the present invention. The downstream flow of data is summarized in FIG. 1. Information is obtained from data source 10 and stored in the server 12. The data is transferred to ground radio transmitter 14 which can transmit through space a data stream for broadcast to satellite or to a terrestrial transmitter 16 which acts as a wireless repeater. Satellite or terrestrial transmitter 16 broadcasts the data stream which is received by receivers 18 within range, which are able to store the information to be viewed by subscribers on handheld or personal computers (PCs) 20. The transmission of data received by a large volume of users simultaneously results in multiplied effective bandwidths, as compared to transmission of data over a network such as the Internet.

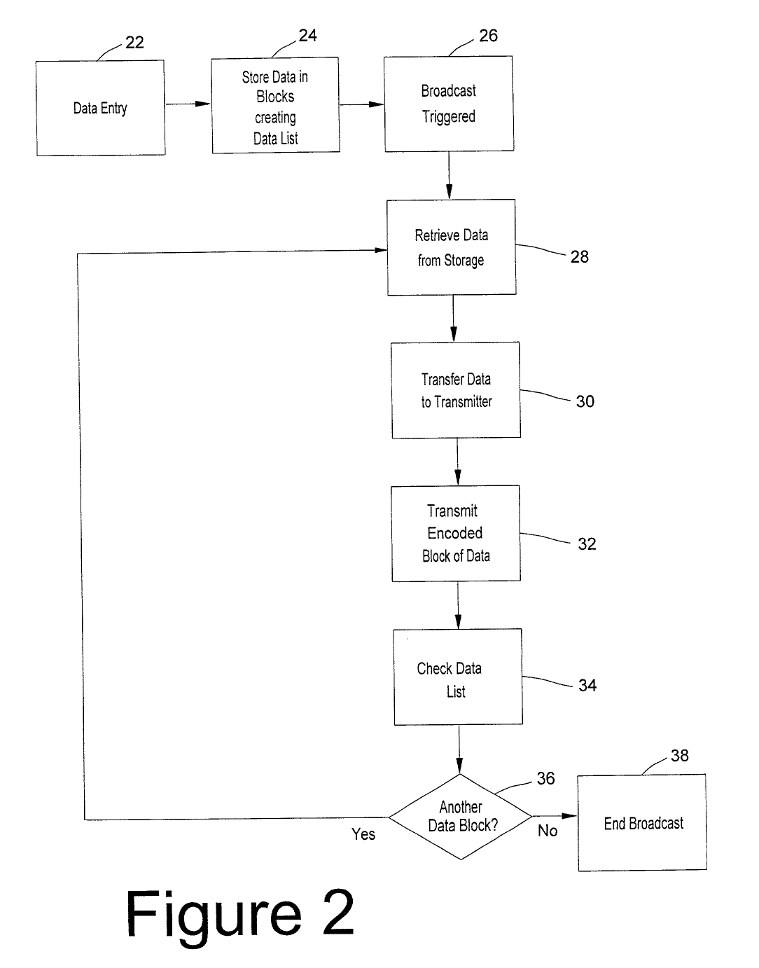

The broadcast operation is involves the process steps illustrated in FIG. 2. Broadcast data is entered at step 22 and stored as data blocks in step 24. This process generates an inventory or control list identifying each block. Once the broadcast is triggered at step 26, either manually or automatically after certain parameters are satisfied, such as upon expiry of a preset period of time or data amount, the stored data is retrieved from storage at step 28. The data is transferred to a transmitter at step 30 and transmitted in step 32 as encoded, encrypted, or in likewise secure form, data.

Optionally, the data list is checked in step 34 after each data block is transmitted to determine whether all the blocks in the list have been transmitted. If another data block must be transmitted, the process returns to the data retrieval step 28, which is illustrated in FIG. 2 as a positive response at step 36, and proceeds to transfer and transmit data according to steps 30, 32 and 34 as before. Once a check of the list at step 34 reveals that all data has been transmitted (or a sufficiently high percentage of the same), the broadcast will end in step 38.

Alternatively, the system may also be set rerun broadcasts any number of times, that is, going from steps 26 to 38, thus improving the chances of full transmission receipt by those subscribers in remote locales, places of high interference or engaging in transit in areas both in and out of range.

As a further alternative, subscribers may be given the option of requesting a rebroadcast of a section if the same is available. In this case availability can be implemented for sections with the greatest demand as counted going back a fixed period of time as bandwidth is available.

The broadcast is received in step 40 by the subscriber via a receiver or transceiver which is connected to a PC or portable processing device. The data list file is checked in step 40, after each data block is received, to make sure all data blocks have been obtained. The data list itself is transmitted. However, the previously transmitted data list is saved and may be used in place of the new data list, until the new data list is received, or in the event the new data list is not received. Data blocks are stored in step 44 until all data blocks are received. To conserve memory space, the subscriber may preset the inventive system to erase and store new data over older existing data. Once a check of the data list shows that all data blocks have been received, the data is processed by the processing device as illustrated in steps 46 and 48. If there is no check of the data list, subsequent broadcasts will be of update and/or replacement articles. The subscriber is alerted to the receipt of a new broadcast in step 50 by a flashing icon, characteristic sound or video, or any other conventional means. The subscriber may then access software stored in memory to view the newly received information, as illustrated in step 52.

The corresponding software of the inventive system is provided to each subscriber and updated in response to each subscriber's interests. Initially, general background information is obtained about the subscriber when the subscriber orders the service offered by the inventive system. This may be accomplished online by filling out a form on a website or also by mail or telephone.

The broadcast information comprises informative articles, news, reviews, advertisements, etc. A first page, which may include images, list of contents and advertisements is provided to the subscriber when the subscriber accesses the broadcast. Many or all of these items are images, video, blurbs, abstracts, headlines or statements paraphrasing the contents of the article, advertisement or piece of information which comprise links that open up a window, web page, file, viewer, video, program, audio, etc., containing the entire article, advertisement or related piece of information. These teasers are designed to provide some information to the subscriber so that a subscriber reading the teaser and interested in obtaining further related information would access the associated link to do so.

Preferably, the link is accessed by an action such as placing a cursor over the link by moving the mouse, mousepad or similar control device, and then clicking or double-clicking the left or right button on the mouse, mousepad or similar control.

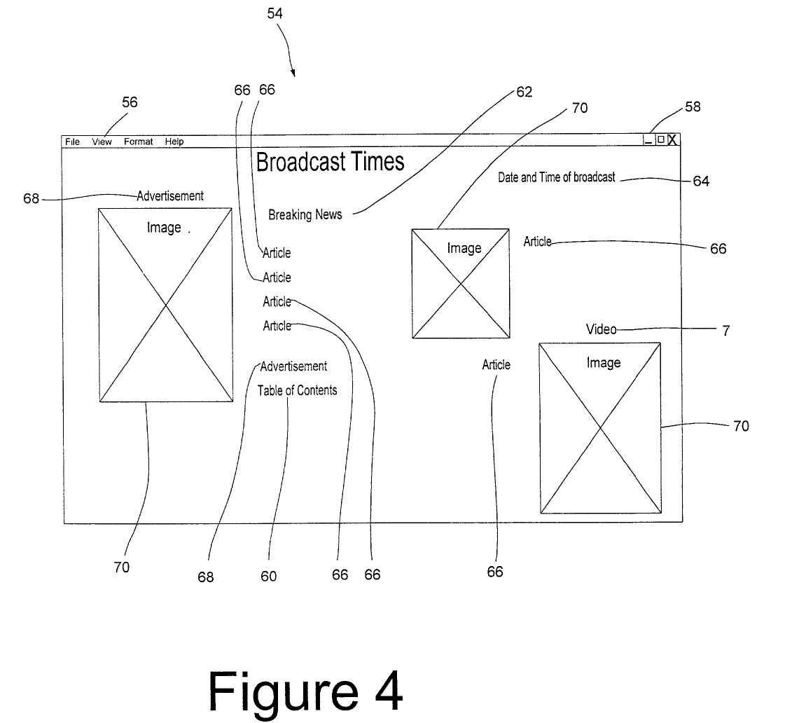

An example of a first page is illustrated in FIG. 4. First page 54 in this embodiment is shown as being in the characteristic Windows operating system format of the most recent versions, having a box-like bordered appearance with a graphical representation of a tool bar menu 56 and shortcut keys 58. Menu 56 may include “pop-up” screens having options and pop-up submenus with further options under each heading.

First page 54 includes a table of contents 60, listing of “breaking” news 62, and date and time of the most recent broadcast 64. Also, first page 54 has multiple article teasers 66 and advertisements 68 comprising links to the full articles or advertisements. Images 70 and video 72, which relate to an article, advertisement or other piece of information, also comprise links to that particular article, advertisement or piece of information.

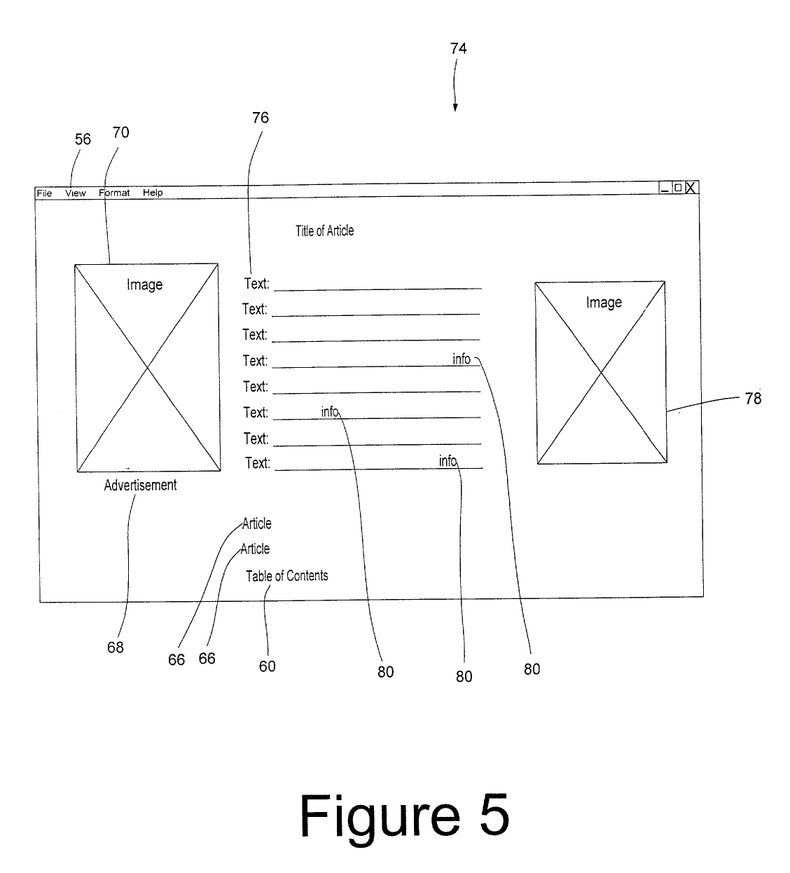

For example, if a subscriber engages an article teaser 66 link, it would cause a second page 74 such as the page shown in FIG. 5 to open. Second page 74 has text 76 comprising the full article, any associated video or images 78 or images 70, advertisements 68 and article teasers 66, comprising links to other pages of information. Also, there are information links 80 within text 76 itself that open other pages, programs, files, etc., comprising further information related to the particular link.

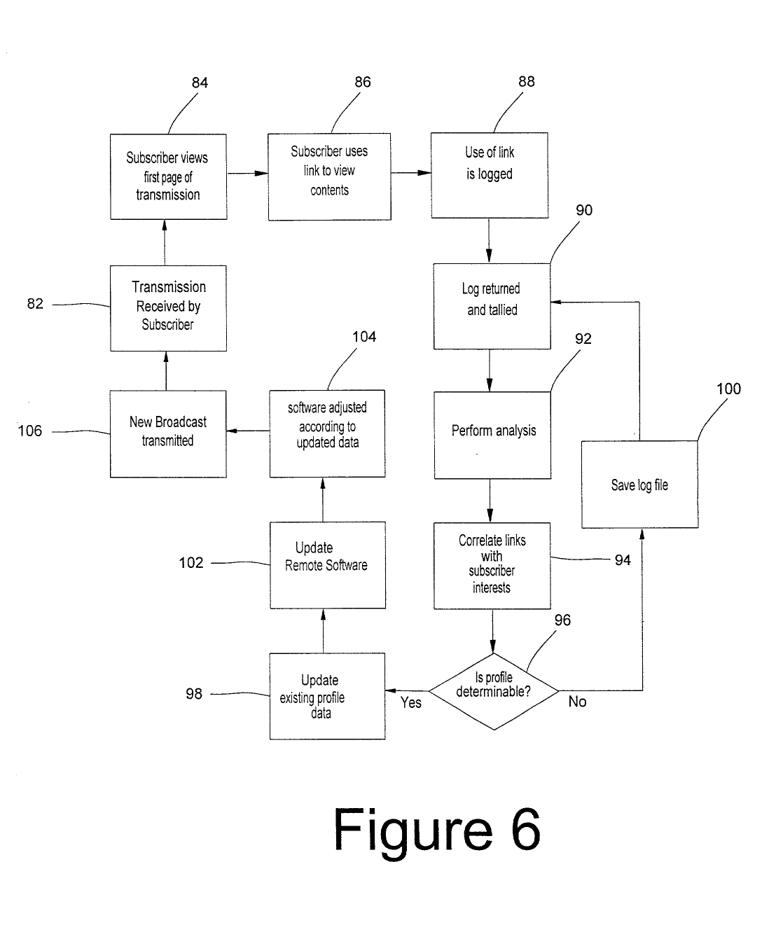

Once again, and referring now to the flow chart illustrated in FIG. 6, after the transmission is received in step 82, the subscriber views the first page in step 84. As shown in steps 86 and 88, when the subscriber uses any link, the use of such link is saved or logged in a data file which is stored in memory.

This log file of link information is constantly being updated by use of links in the inventive system. Information regarding the nature or category of link may also be inherent in the link name or address, such as the type of product (if it relates to an advertisement) or news story (sports, politics, stocks, etc.), or encoded in the link name or log file in some other manner. The log files include an identification system or personal code exclusive to each subscriber.

Such log files may be stored locally for example on the hard drive of the user's PC. These log files are transferred back to server 12 and the link information contained therein is tallied in step 90. Preferably, the log file is set to be automatically transferred when the subscriber is online, or may be triggered by accessing a link in the inventive system that requires the subscriber to be online to view the information sought.

Upon its return, the log file is analyzed to determine the subscriber's interests based on the links used in steps 92 and 94, in order to develop a subscriber profile. If the information is sufficient to ascertain a profile, thus providing a positive response in step 96, the existing profile information is updated with the newly developed profile information in step 98. The existing profile information may have been generated based on the original information entered when the subscriber first joined the system or be based on the profile developed from the last received log file.

If the information is insufficient for ascertaining a profile, no changes will be made to the existing profile, the log file is saved in step 100 and the system waits for a new log to be returned in step 90. The information in the new log file will be combined with the saved log file for analysis and profile development in steps 92 and 94.

After updating the profile data in the server in step 98, the remote software, that is, software on the subscriber's computer, is updated in step 102. In step 104, the software on the subscriber's computer is adjusted in accordance with the updated information. The adjustments may include alteration of the remote software so that a different amount or proportion of certain information and links of a particular type (of the type that would likely be of interest to the subscriber based on the subscriber's profile) in the new broadcast in step 106 is processed and provided to the subscriber, changes in the placement of information, articles, advertisements, etc., or addition of special offers that would likely be of interest to the subscriber based on the subscriber's profile. Thus, the broadcast received at the subscriber's PC is processed, filtered and supplied to the subscriber in a manner that highlights the portions of the magazine deemed to be of greatest interest to the subscriber. In this manner the broadcast may constantly evolve with the subscriber without depriving the subscriber of the basic information-providing purpose, by using the table of contents (which may be based on transmittal information with markers indicating the position of such information in a particular scheme) to provide links to all stories or articles available, use of which further stimulates the cycle of change and alteration to the system.

Also, the profiles of all subscribers may be used to develop a general profile to alter the entire broadcast accordingly, thus better serving the subscriber population.

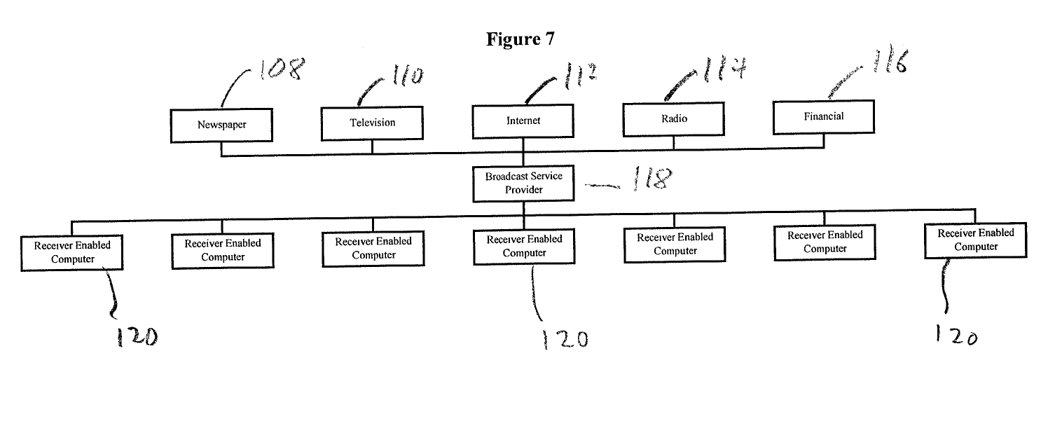

FIG. 7-9 illustrate another embodiment of the present invention. Newspaper 108, Television 110, Internet 112, Radio 114, and Financial 116 are shown in FIG. 7 as an example of the type of multimedia data suppliers or sources that may be used in accordance with the present invention. The number of data suppliers can be as many as the broadcast capacity allows, or as few as desired based on factors such as whether or not new information from the supplier or source exists or customer preference. Broadcaster 118 of the multimedia data includes any transmitting device, using any wavelength that is capable of delivering multimedia data, in accordance with this invention, such as a cell phone type transmitter, to transmit a broadcast to be received by the receiver-enabled computers 120. Receiver-enabled computers 120 may comprise a built in receiver and memory capacity or a separate receiver module which interfaces with the computer. Preferably, in the embodiment of the present invention using a cell phone type transmitter, the receiver-enabled computers 120 are not be required to initialize with the broadcaster, but instead initialize independently or via the receiver module.

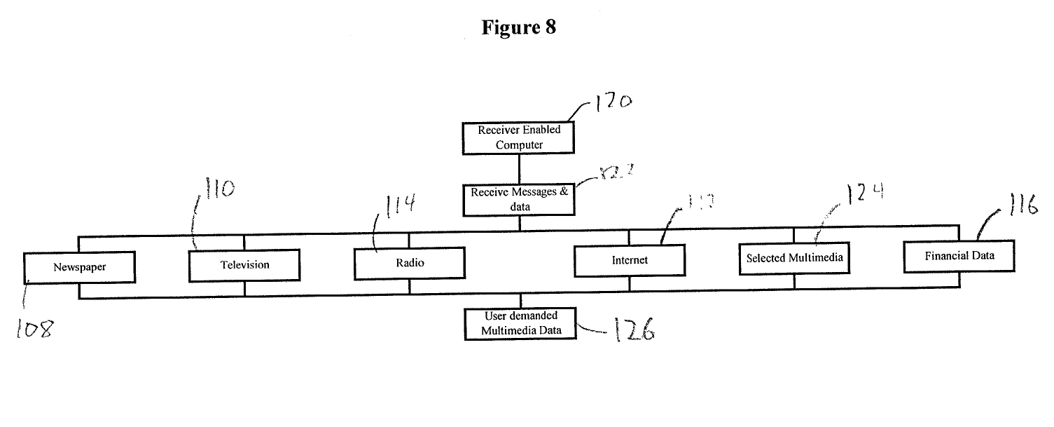

As illustrated in FIG. 8, receiver-enabled computer 120 receives messages and data in step 122 which are to be presented to the user. Additionally, the user may select certain items or subjects of interest to be stored and presented separately. This selected multimedia 124 is obtained by searching the incoming multimedia data. In step 126, the data received is available to the user upon demand, which may be via a software-user interface or “skin” comprising representations of buttons or the like that actuate the presentation of incoming data from the various multimedia sources.

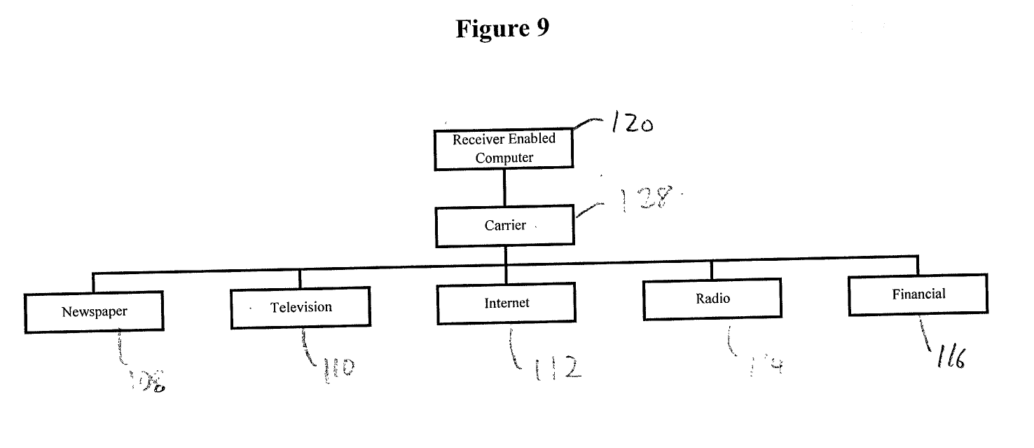

FIG. 9 illustrates an example of the user feedback attainable in accordance with the system. The user may contact the broadcaster or various sources of multimedia data via any carrier 128 of information, such as the Internet, e-mail, telephone, cell phone, postal service, etc., to obtain customer service or effectuate changes or alterations in service.

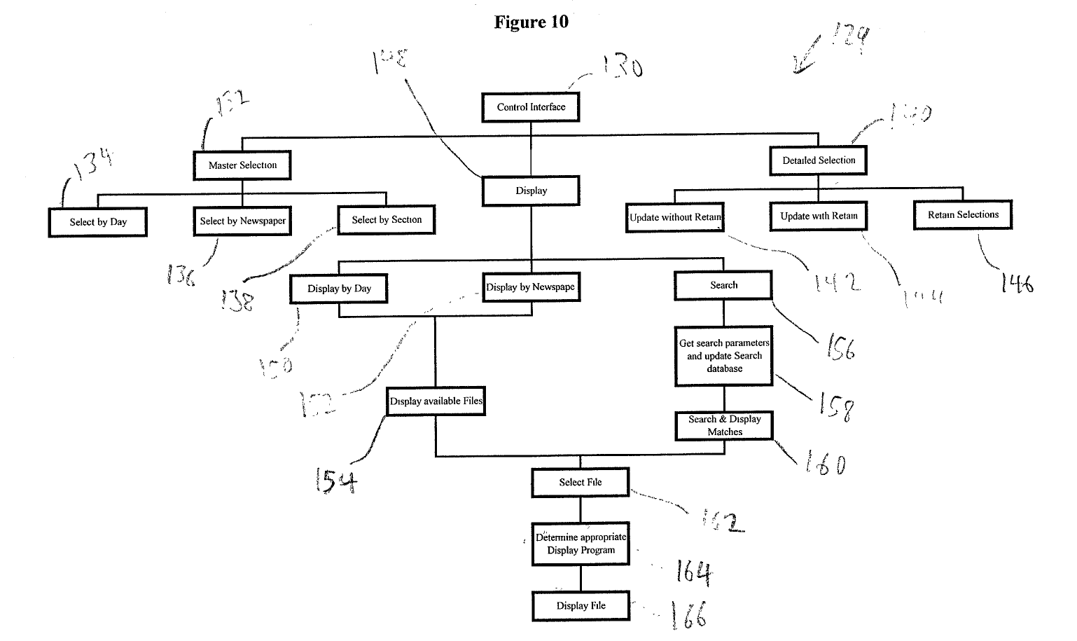

A flow diagram of a control system 129 usable with the present invention to set user preferences and access incoming data is shown in FIG. 10. Multimedia newspapers in accordance with the present invention is used as a means for illustrating the features of control system 129. Control system 129 may also be used with other sources of multimedia data. The user opens a control program interface 130 having representations of buttons to access its various features. The master selection feature 132 provides the user with a means for selecting a particular day 134, newpaper 136 or section 138 to be received and stored in memory. Detailed selection 140 provides the user with the options to update without retaining older information in step 142, update with retaining older information in step 144 or to retain only certain selections in step 146. The display step 148 provides the user with the options to display by day 150 or by newspaper in step 152. The control program displays the available files in step 154 according to the chosen option. Additionally, a search may be performed, using parameters provided by the user, which is then entered into a search database and all files matching the search parameters are displayed to the user, as shown in steps 156, 158 and 160. Preferably, the files are displayed as a list of hyperlinks. Once the user has selected a file to be actuated in step 162 the program determines the appropriate program to display or present the file to the user in steps 164 and 166. In most operating systems, identification of the appropriate program is made through the file extension (e.g., .wpd, .dwg, .doc) which indicates the applicable source program from which the file originates.

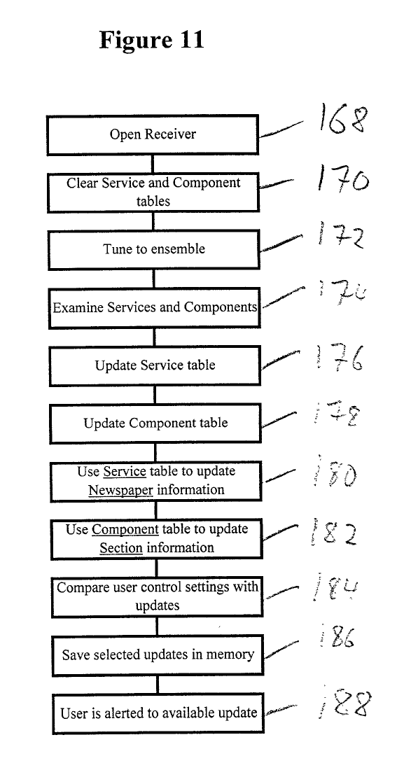

FIG. 11 illustrates a flow diagram for another embodiment of the present invention wherein the multimedia files are transmitted via digital radio or digital audio broadcasting (DAB). As currently implemented, the DAB transmission is made up of a range of tuneable frequencies or frequency bands called ensembles. Within each ensemble there may be several services, and within each service there may be several components. The example of a newspaper is used as a means for illustrating the features although other multimedia data from any source could be used with this embodiment. In the case of broadcasting a newspaper, a particular newspaper can occupy a service within a given ensemble and a section of the newspaper (e.g., national, local, business, sports, etc.) can occupy a component within the service. However, the ensemble may be different for each broadcast. The services and component information from the previous received ensemble is stored in service and component tables. After activating or “opening” the broadcast receiver, which is associated with a computer or memory, in step 168, the previous broadcast information (i.e., service and component tables), is cleared, as shown in step 170. After clearing the previous information, the next ensemble is tuned and the services and components within the ensemble are examined in steps 172 and 174. After scanning the entire new ensemble, the new service and component information is used to update the service and component tables in steps 176 and 178. Continuing to using a newspaper as an example, the service and component tables update the newspaper and section information in steps 180 and 182. A control program is used to examine and compare the update to the newspaper and section information with the user control settings in step 184. The broadcasted information desired or selected by the user is saved in memory in step 186 and the user is alerted to its availability in step 188.

While illustrative embodiments of the invention have been described above, it is, of course, understood that various modifications will be apparent to those of ordinary skill in the art. Many such modifications are contemplated as being within the spirit and scope of the invention.

1. An electronic distribution system for mass distribution of multimedia simultaneously to numerous end users, comprising,
(a) a memory device for storing multimedia as a plurality of data blocks;
(b) a wireless transmitter associated with said source memory device for transmitting said data blocks as a wireless data stream
(c) a plurality of remote receivers, each remote receiver being associated with one of a plurality of end users, said receivers receiving said wireless data stream transmitted by said transmitter and outputting said data stream as an electrical signal; and
(d) a plurality of computing devices, each of said computing devices being associated with a respective one of said receivers, each said computing device comprising a local memory device, software being resident in said local memory device, said software comprising instructions controlling the processing of said data stream, each said remote receiver and its associated computing device cooperating to convert said wireless data stream back into said data blocks, said software being configured to store said data blocks in said local memory device, and being further configured to provide end users with access to said multimedia data.

2. A system as in claim 1, wherein said wireless transmitter comprises a satellite, and said source memory device is located on the surface of the earth and is coupled to said satellite through the use of a wireless ground transmitter.

3. A system as in claim 1, wherein said data stream further comprises a listing identifying each data block transmitted.

4. A system as in claim 1, wherein said multimedia data comprises a newspaper.

5. A system as in claim 1, wherein said multimedia data comprises viewable information having links to other information, said links being actuators for providing the end user with access to the other information.

6. A system as in claim 5, wherein said links are accessible over a wireless system and/or through a computer network such as the Internet.

7. A system as in claim 5, wherein said other information comprises data stored in said local memory device.

8. A system as in claim 5, wherein said other information comprises data stored in a remote memory device, said remote memory device being part of the infrastructure of a computer network.

9. A system claim 1, wherein said multimedia comprises text and/or photographs and/or video sequences and/or games and/or music and/or animation, and said multimedia is compressed to reduce bandwidth requirements.

10. A system as in claim 1, wherein the contents of said multimedia data is periodically updated through the transmission of substitute data blocks which are substituted in memory for already transmitted data blocks having a common identifier.

11. A system as in claim 1, wherein computing devices associated with users are periodically queried to ensure that data is well received.

12. A system as in claim 1, wherein users are given the option of requesting retransmission of a data block, and data blocks are transmitted when a minimum number of user requests for retransmission of a data block are received, said minimum number being determined by available bandwidth in the electronic distribution system.

13. A system as in claim 1, wherein the software configured to provide end users with access to said multimedia data, searches for patterns in accessing of said data by said end users to develop the user profile

14. A system as in claim 13, wherein said user profile determines the organization and/or content of information stored in accessible on a computer associated with a particular end user.

15. A method of distributing multimedia data to a plurality of end users simultaneously comprising:
(a) entering the multimedia data into a processing device;
(b) storing the multimedia data as individual data blocks in memory;
(c) creating a list identifying said data blocks in memory;
(d) transmitting said data blocks from memory as a data stream with a wireless transmitter; and,
(e) checking said list and the received content of said data blocks to determine which of said data blocks have been well received.

16. A method as in claim 15, wherein said list and said received data block content is checked after each data block is transmitted.

17. A method as in claim 15, further comprising:
(f) transmitting any data blocks listed but not transmitted.

18. A method as in claim 15, wherein said multimedia data comprises a newspaper.

19. A method of receiving multimedia data from a celestial transmitting source, comprising:
(a) receiving, over a plurality of receivers, a wireless transmission of data blocks as a data stream from the transmitting source;
(b) receiving a list identifying the data blocks transmitted;
(c) checking said list;
(d) processing said data blocks with a computer; and
(e) presenting said data blocks for viewing by a user using the computer.

20. A method as in claim 19, wherein said presenting said data blocks for viewing by a number of users simultaneously comprises:
(i) entering the multimedia data into processing device;
(ii) storing the multimedia data as individual data blocks in memory;
(iii) creating a list identifying said data blocks in memory; and
(iv) transmitting said data blocks from memory as a data stream with a wireless transmitter.

21. A method as in claim 19, wherein said list is checked after receiving each data block.

22. A method as in claim 19, wherein said data blocks are presented in a format corresponding to the operating system in the memory of the computer.

23. A method as in claim 20, further comprising:
(f) said presenting includes presentation of interactive multimedia data and information having viewable links to a plurality of the interactive multimedia data and information, said links being accessible to the user for actuating the plurality of other interactive multimedia data and information, said links each having individual identifiers.
(g) recording the links accessed by said user;
(h) associating said recorded links with specific interest groups, said specific interest groups being associated with the multimedia data and information actuated by said user; and,
(i) categorizing and organizing said associated specific interest groups to develop a profile of said users interests.

24. A method as in claim 23, wherein said profile is continuously developed by said user accessing links.

25. A method as in claim 23, wherein said identifiers comprise interest-identifying information.

26. A method as in claim 23, further comprising:
(j) presenting said user with varied amounts and/or organization of multimedia data and information in accordance with the developed profile.

27. A method as in 26, further comprising:
(k) updating said profile periodically.

28. A method as in claim 24, wherein said recorded links are stored in memory.

29. A method as in claim 27, further comprising:
(l) categorizing and organizing said associated specific interest groups to develop a general profile of all users interests.

30. A system as in claim 1, wherein users are given the option of requesting transmission of a data block, said request causing transmission of said data block by said transmitter.
